(19) United States
(12) Patent Application Publication
(10) Pub. No.: US 2024/0347848 A1
(43) Pub. Date: Oct. 17, 2024

(54) HOUSING FOR BATTERY, BATTERY CELL INCLUDING THE SAME, AND METHOD OF MANUFACTURING THE SAME

(71) Applicant: SK On Co., Ltd., Seoul (KR)

(72) Inventors: Jae Sik SHIN, Daejeon (KR); Jae Gyu BYUN, Daejeon (KR); Gi Jeong SEO, Daejeon (KR); Seung Hoon JU, Daejeon (KR)

(21) Appl. No.: 18/626,333

(22) Filed: Apr. 4, 2024

(30) Foreign Application Priority Data
Apr. 17, 2023 (KR) 10-2023-0050203

(51) Int. Cl. H01M 50/342; B23K 26/21; H01M 50/15

(52) U.S. Cl. CPC H01M 50/3425; B23K 26/21; H01M 50/15

(57) ABSTRACT

A battery cell is provided. The battery cell comprising a housing having an internal space in which an electrode assembly is accommodated; a cap assembly coupled to the housing and closing the internal space; and a vent member coupled to the housing and configured to open when internal pressure of the housing is equal to or higher than a reference value, wherein the vent member is coupled to an inner side of the housing.

### CROSS-REFERENCE TO RELATED APPLICATIONS

This patent document claims the priority and benefits of Korean Patent Application No. 10-2023-0050203 filed on Apr. 17, 2023, the disclosure of which is incorporated herein by reference in its entirety.

### TECHNICAL FIELD

The disclosure and implementations disclosed in this patent document generally relate to a housing for a battery, a battery cell including the same, and a method of manufacturing the same.

### BACKGROUND

Unlike primary batteries, secondary batteries are convenient in that they may be charged and discharged, and are thus receiving a lot of attention as a power sources for various mobile devices, electric vehicles, and the like.

Such a secondary battery may have a form in which a positive electrode plate, a separator, and a negative electrode plate are accommodated in a housing (or a case) having a predetermined degree of rigidity. The housing may have various shapes, such as a prismatic, pouch-shaped, or cylindrical shape.

The housing of a secondary battery may have a shape with one side open so that an electrode assembly may be accommodated therein. A cap plate having a terminal portion may be coupled to one open side to close the interior of the housing.

During use, gas may be generated inside secondary batteries due to harsh charging and discharging conditions, external shocks or the like, and as a result, the internal pressure of the housing increases and there is a risk of explosion. To prevent this, a component (a vent member) for gas discharge may be disposed on the cap plate, but in this case, there is a problem in that the gas discharge direction is limited to a direction in which the cap plate is installed.

### SUMMARY

The present disclosure can be implemented in some embodiments to provide a battery cell in which a vent member is coupled to the inside of a housing.

The present disclosure may be implemented in some embodiments to provide a battery cell having a structure in which a vent member may be stably coupled to a housing.

In some embodiments of the present disclosure, a battery cell includes a housing having an internal space in which an electrode assembly is accommodated; a cap assembly coupled to the housing and closing the internal space; and a vent member coupled to the housing and configured to open when internal pressure of the housing is equal to or higher than a reference value. The vent member is coupled to an inner side of the housing.

The housing may further include a venting hole with the vent member being seated therein, and the vent member may be seated in the venting hole in a direction from an inside to an outside of the housing.

The venting hole may include a step portion, and the vent member may include a seating portion seated on the step portion. The seating portion may be disposed closer to the electrode assembly than the step portion.

A width of the venting hole may be narrower than a width of the vent member.

The housing may include a joint including a first joint and a second joint facing and coupled to each other.

The housing may further include a venting hole to which the vent member may be coupled, and the joint may be disposed on a side opposite to the venting hole.

The first joint and the second joint may be welded to each other along a joint line, and the joint line may be formed in a longitudinal direction of the housing.

A step may be formed in a position in which the first joint and the second joint come into contact with each other.

The housing may have an open shape at both ends in a longitudinal direction, and the cap assembly may be coupled to both ends of the housing.

The cap assembly may include a terminal portion electrically connected to the electrode assembly.

The vent member may include a notch portion configured to be broken by internal pressure of the housing.

One surface of the vent member may face the electrode assembly, and the notch portion may be disposed on the other surface opposite to the one surface of the vent member.

In some embodiments of the present disclosure, a method of manufacturing a battery cell includes seating a vent member on an inner side of a housing; combining the vent member and the housing; and combining an electrode assembly and a cap assembly with the housing. The vent member is configured to open when internal pressure of the housing is equal to or higher than a reference value.

The housing may include a joint configured to be openable, and the combining of the vent member and the housing may further include irradiating a welding laser to a joint area of the inner side of the housing through the joint that is open; and closing the joint.

The joint may include a first joint and a second joint, configured to contact with each other, and the closing of the joint may include joining the first joint and the second joint along a joint line formed in a longitudinal direction of the housing.

The vent member and the joint may be disposed on two opposing surfaces of the housing, respectively.

The combining of the electrode assembly and the cap assembly with the housing may further include inserting the electrode assembly into an internal space of the housing; and combining the cap assembly with both sides of the housing.

The vent member may be seated in a venting hole of the housing in a direction from an inside to an outside of the housing, and a width of the venting hole may be narrower than a width of the vent member.

In some embodiments of the present disclosure, a housing for a battery includes a body portion having an internal space in which an electrode assembly is accommodated. The body portion includes a first surface on which a joint configured to be opened and closed is disposed; and a second surface in which a venting hole configured to allow gas generated in the internal space to be discharged is disposed.

The joint may include a first joint and a second joint configured to contact and be joined to each other.

The body portion may be formed of a plate-shaped member bent at least once, and at least portions of edges of the plate-shaped member on both sides may form the first joint and the second joint.

The housing for a battery may further include a first opening and a second opening disposed in both ends of the body portion in a first direction, and the first surface and the second surface may oppose each other in a second direction, perpendicular to the first direction.

The housing for a battery may further include a vent member coupled to the venting hole and configured to open when internal pressure of the internal space is equal to or higher than a reference value.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell.

FIG. 2 is a bottom perspective view of a battery cell.

FIG. 3 is an exploded perspective view of a battery cell.

FIG. 4 is an example diagram illustrating the combination of a housing of a battery cell and a vent member.

FIG. 5 illustrates a state in which a vent member is coupled to the inside of a housing.

FIG. 6 is a cross-sectional view of a housing taken along line I-I′ of FIG. 3.

FIG. 7 is an enlarged view of portion A of FIG. 6.

FIG. 8 is an enlarged view of portion B of FIG. 6.

FIG. 9 illustrates a state in which a joint of a housing is open.

FIG. 10 is a partial cross-sectional view of a housing according to another embodiment.

FIG. 11 is a cross-sectional view of a housing according to another embodiment.

FIG. 12 is a cross-sectional view of a housing according to another embodiment.

FIG. 13 is a flowchart illustrating a method of manufacturing a battery cell.

FIG. 14 is an example diagram illustrating a combining process of a housing and a vent member.

### DETAILED DESCRIPTION

Features of the present disclosure disclosed in this patent document are described by example embodiments with reference to the accompanying drawings.

Prior to the detailed description of the present disclosure, terms or words used in the specification and claims should not be construed as limited to their usual or dictionary meanings, and should be interpreted with meaning and concept consistent with the technical idea of the present disclosure, based on the principle that the inventor can appropriately define the concept of terms to explain his or her invention in the best way. Therefore, the embodiments described in this specification and the configurations illustrated in the drawings are only the most preferred embodiments of the present disclosure and do not represent the entire technical idea of the present disclosure.

The same reference numbers or symbols in respective drawings attached to this specification indicate parts or components that perform substantially the same function. For convenience of explanation and understanding, different embodiments may be described using the same reference numerals or symbols. For example, even if components having the same reference number are illustrated in multiple drawings, the multiple drawings do not all represent one embodiment.

In the following description, singular expressions include plural expressions unless the context clearly dictates otherwise. Terms such as “include”, “configure” and the like are intended to designate the presence of features, numbers, steps, operations, components, parts, or combinations thereof described in the specification, and should be understood as not precluding the presence or addition of one or more other features, numbers, steps, operations, components, parts, or combinations thereof.

In addition, in the following description, expressions such as upper side, upper portion, lower, bottom, side, front, rear, and the like are expressed based on the direction illustrated in the drawing, and it should be noted in advance that if the direction of the object is changed, it may be expressed differently.

Additionally, in this specification and claims, terms including ordinal numbers such as “first”, “second”, and the like may be used to distinguish between components. These ordinal numbers are used to distinguish identical or similar components from each other, and the meaning of the term should not be interpreted limitedly due to the use of these ordinal numbers. For example, components combined with these ordinal numbers should not be interpreted as having a limited order of use or arrangement based on the number. If necessary, respective ordinal numbers may be used interchangeably.

Hereinafter, example embodiments of the present disclosure will be described with reference to the attached drawings. The shapes and sizes of elements in drawings may be exaggerated for clearer explanation.

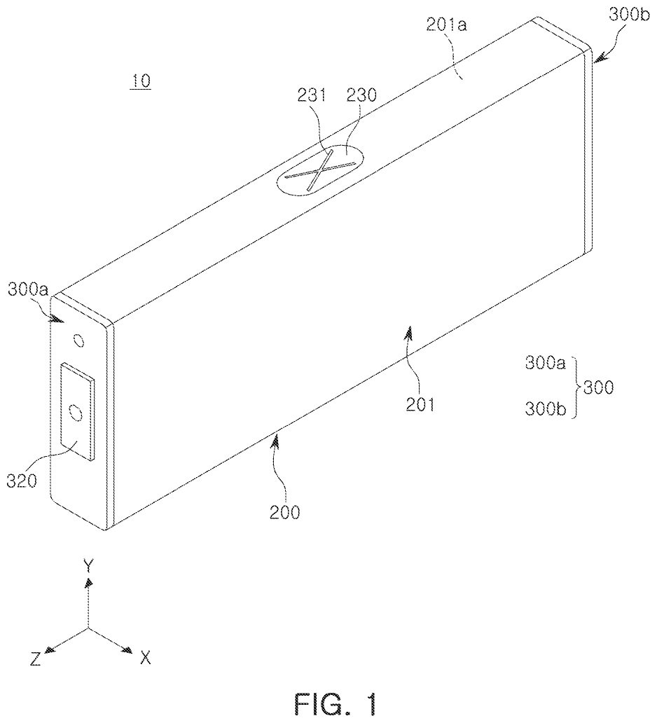

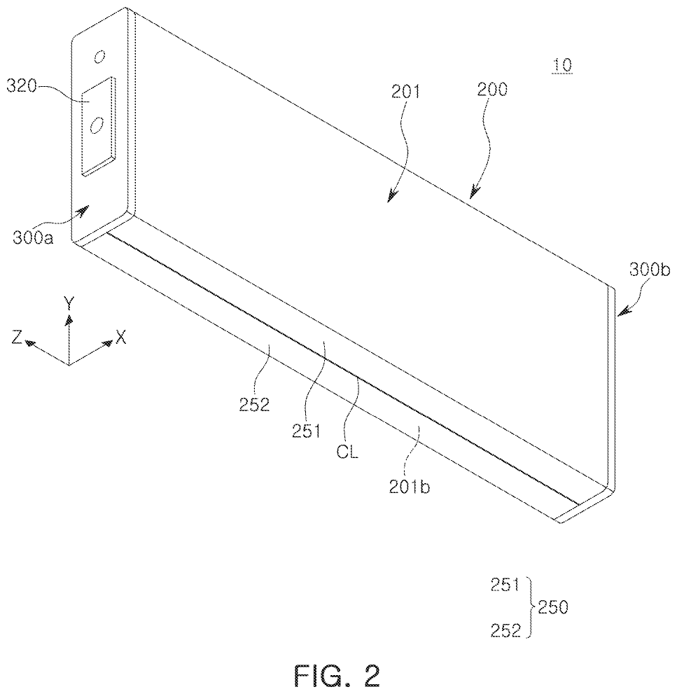

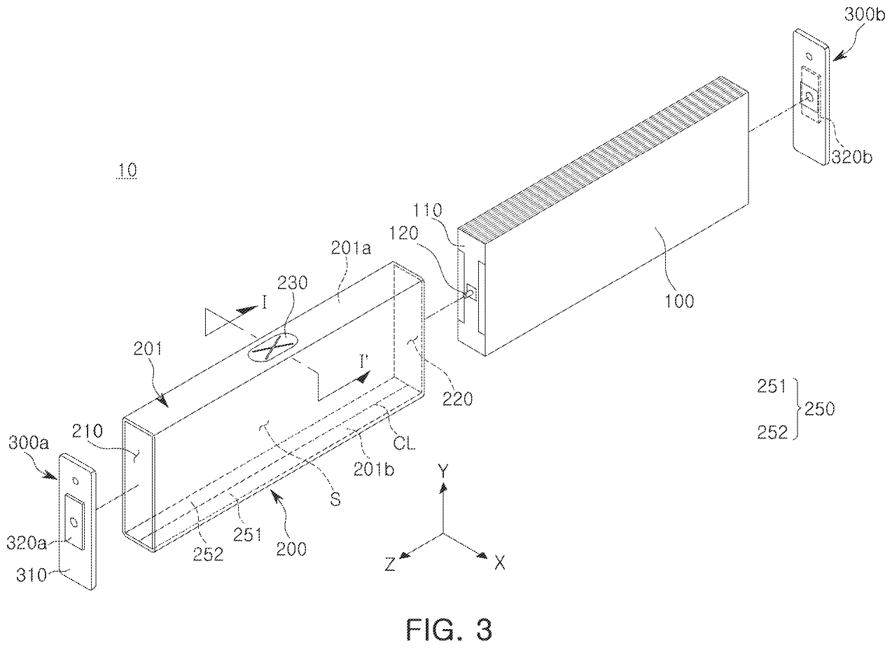

FIG. 1 is a perspective view of a battery cell 10. FIG. 2 is a bottom perspective view of the battery cell 10. FIG. 3 is an exploded perspective view of the battery cell 10.

The battery cell 10 according to embodiments may include an electrode assembly 100, a housing 200 in which the electrode assembly 100 is accommodated, and a cap assembly 300 in which a terminal portion 320 electrically connected to the electrode assembly 100 is disposed.

The electrode assembly 100 may include a plurality of electrode plates. The plurality of electrode plates may include a plurality of positive electrode plates and a plurality of negative electrode plates. The electrode assembly 100 may be composed of a positive electrode plate and a negative electrode plate wound or stacked with a separator therebetween. Uncoated portions in which no active material is applied may be formed on the plurality of positive electrode plates and the plurality of negative electrode plates. In the positive and negative electrode plates, respective uncoated portions may be connected so that the same polarities contact each other. The uncoated portions of the same polarity are connected to a current collector 110, and the current collector 110 may be electrically connected to the terminal portion 320 of the cap assembly 300 through a connecting member 120. Therefore, the electrode assembly 100 may be electrically connected to other components (for example, a conductive bus bar) external to the battery cell 10.

The housing 200 according to embodiments may be a housing generally used in manufacturing a battery device. Unless otherwise specified in the description below, the housing 200 may refer to a housing for a battery.

The housing 200 may have an internal space S in which the electrode assembly 100 and the electrolyte (not illustrated) may be accommodated.

The housing 200 may protect the electrode assembly 100 therein and may include a material with sufficient rigidity to maintain the external shape of the entire battery cell 10. For example, at least a portion of the housing 200 may be formed of aluminum. However, the material of the housing 200 is not limited thereto and may include various metals or resin materials other than aluminum.

The housing 200 may include a body portion 201 that has the internal space S and has an open shape on both sides. For example, referring to FIGS. 1 to 3, the body portion 201 of the housing 200 may have a substantially hexahedral shape, the internal space S may be formed between a first opening 210 and a second opening 220 disposed in both ends of the body portion 201 in the longitudinal direction (Z-axis direction), and the electrode assembly 100 may be accommodated in this internal space S.

In the following description, embodiments will be described on the assumption that the body portion 201 of the housing 200 has a hexahedral shape with both sides open as illustrated in FIGS. 1 to 3. However, a detailed shape of the housing 200 is not limited to that illustrated in FIGS. 1 to 3. The housing 200 may have any shape as long as it secures an internal space S into which the electrode assembly 100 may be inserted and accommodated. For example, the housing may have the shape of a circular pillar with the top or bottom open, or may have the shape of a polyhedron with at least one side open.

The cap assembly 300 may be coupled to the housing 200 and close the internal space S. For example, the cap assembly 300 may be respectively coupled to the first opening 210 and the second opening 220 of the housing 200 to close the internal space S.

The cap assembly 300 may include a cap plate 310 coupled to the housing 200 and a terminal portion 320 disposed on the cap plate 310.

The terminal portion 320 may be electrically connected to the electrode assembly 100 inside the housing 200. For example, referring to FIG. 3, the terminal portion 320 may be electrically connected to the electrode assembly 100 via the current collector 110 and the connecting member 120 which are electrically connected to the electrode assembly 100.

The terminal portion 320 may be fixedly disposed on the cap plate 310. The cap plate 310 may form one side of the battery cell 10.

The cap plate 310 includes a material having a predetermined rigidity, and may close one open side of the housing 200 and protect the electrode assembly 100 disposed in the internal space S. For example, at least a portion of the cap plate 310 may be formed of the same material as a material of the housing 200.

In one battery cell 10, the cap assembly 300 may be in plural. For example, the cap assembly 300 may include a first cap assembly 300a and a second cap assembly 300b in which terminal portions 320 having opposite polarities are respectively disposed.

As illustrated in FIGS. 1 to 3, the first cap assembly 300a and the second cap assembly 300b may be coupled to both ends of the housing 200. For example, the first cap assembly 300a has a positive terminal portion 320a and may be coupled and welded to the first opening of the housing 200 to close the first opening. The second cap assembly 300b has a negative terminal portion 320b and may be coupled and welded to the second opening 220 of the housing 200 to close the second opening 220. Accordingly, the first cap assembly 300a and the second cap assembly 300b may close both sides of the housing 200 in which the electrode assembly 100 is accommodated.

A laser welding method may be applied to join the cap assembly 300 and the housing 200, but the detailed joining method is not limited thereto.

In the case of the battery cell 10 illustrated in FIGS. 1 to 3, the two terminal portions 320 are illustrated as being disposed on opposite sides of the housing 200, but may also be configured to face the same direction on one side of the housing 200. In this case, unlike FIGS. 1 to 3, the cap assembly 300 may be configured in such a manner that two terminal portions 320 with opposite polarities are disposed on one cap plate 310.

The battery cell 10 may further include a vent member 230 configured to allow gas generated in the internal space S to be discharged. When the internal pressure of the battery cell 10 is equal to or higher than the reference value, the vent member 230 opens earlier than other areas of the battery cell 10 to prevent the battery cell 10 from exploding.

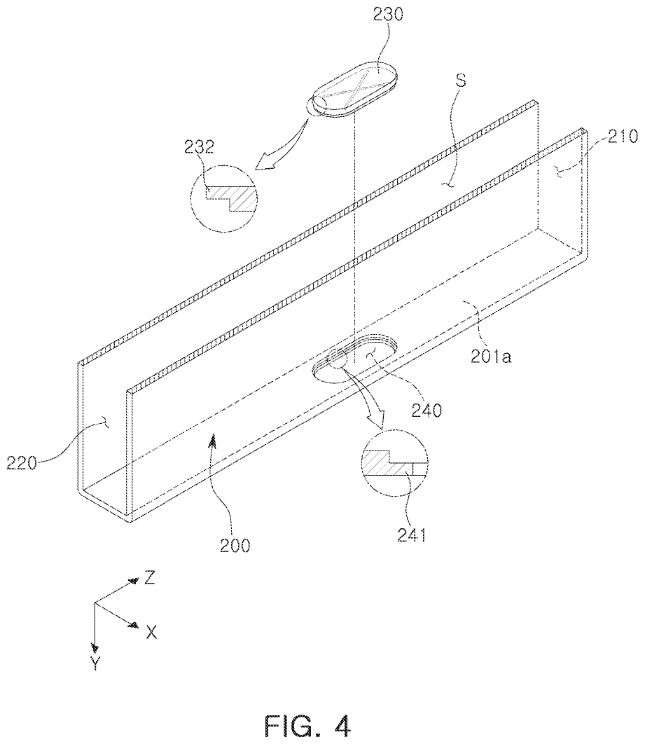

The vent member 230 may be coupled to the body portion 201 of the housing 200. For example, the vent member 230 may be coupled to or seated in a venting hole (for example, 240 in FIG. 4) formed on the side of the body portion 201. The venting hole 240 may be configured to allow gas generated in the internal space S to be discharged is disposed.

The vent member 230 may be configured to be coupled to the venting hole 240 and close the venting hole 240. When the internal pressure of the housing 200 is lower than the reference value, the vent member 230 is configured to seal the venting hole 240, and thus to block foreign substances from entering the battery cell 10 or the electrolyte from flowing out of the battery cell 10 through the venting hole 240.

In the case in which gas is generated in the internal space S of the housing 200 while the battery cell 10 is repeatedly charging and discharging, and the internal pressure becomes equal to or higher than the reference value, at least a portion of the vent member 230 may be configured to break. For example, the vent member 230 may include a notch portion 231 configured to be broken by internal pressure of the housing 200. The notch portion 231 may have a smaller thickness than other portions of the vent member 230. For example, in the case in which the internal pressure of the housing 200 becomes equal to or higher than the reference value, the notch portion 231 may be preferentially broken in the vent member 230, and gas in the internal space S may be discharged to the outside of the battery cell 10 through the broken notch portion 231.

The vent member 230 may be seated on and coupled to the inner side of the housing 200. For example, the vent member 230 may be seated in the venting hole 240 of the housing 200 in a direction from the inside of the battery cell 10 toward the outside and then firmly coupled thereto by laser welding. However, various coupling methods other than welding may be applied to the coupling between the vent member 230 and the housing 200. For example, the vent member 230 and the housing 200 may be coupled to each other through a bonding material such as an adhesive or the like. Alternatively, the vent member 230 and the housing 200 may be fitted and coupled with a sealing member interposed therebetween.

In some embodiments, the battery cell 10 may further include a joint 250 provided to couple the housing 200 and the vent member 230 to each other. For example, the joint 250 including a first joint 251 and a second joint 252 that are separable from each other may be formed on one side of the housing 200. The first joint 251 and the second joint 252 may be configured to contact and be joined to each other.

The body portion 201 of the housing 200 may include a first surface 201b on which the joint 250 is disposed and a second surface 201a on which the vent member 230 is disposed. A venting hole (for example, 240 in FIG. 4) may be formed in the second surface 201a of the housing so that the vent member 230 may be seated.

The joint 250 may be disposed on a side opposite to the venting hole 240. The joint 250 and the vent member 230 may be disposed on opposite sides of the body portion 201. For example, the first surface 201b and the second surface 201a of the body portion 201 may be opposite surfaces. For example, referring to FIGS. 1 to 3, the vent member 230 is disposed on the upper surface of the body portion 201 of the battery cell 10, and the joint 250 may be disposed on the lower surface of the body portion 201.

The first joint 251 and the second joint 252 of the joint 250 may be configured such that ends thereof face each other and contact each other. A step may be formed in a position in which the first joint 251 and the second joint 252 come into contact with each other.

The first joint 251 and the second joint 252 are joined to each other during the manufacturing process of the battery cell 10, and may be in a mutually coupled state in the final product.

For example, during the manufacturing process of the battery cell 10, at a stage before the vent member 230 is coupled to the housing 200, the first joint 251 and the second joint 252 may be in a state where they are not bonded to each other. In this case, the first joint 251 and the second joint 252 may be spaced apart from each other at a predetermined interval, or may not be tightly joined even if they are in contact with each other. Therefore, at this stage, the joint 250 may expose the internal space of the housing 200. In addition, if the first joint 251 and the second joint 252 of the joint 250 are in contact with each other, the user (or manufacturer) may open the joint 250 by separating the first joint 251 and the second joint 252 from each other.

At a stage after the vent member 230 is coupled to the housing 200, the first joint 251 and the second joint 252 may be firmly joined to each other. For example, the first joint 251 and the second joint 252 may be firmly joined to each other by welding. However, various joining methods other than welding may be applied to joining the first joint 251 and the second joint 252. As the first joint 251 and the second joint 252 are joined to each other, the joint 250 is in a closed state.

A joint line CL, which is an area where the first joint 251 and the second joint 252 are joined or welded to each other, may be formed in the joint 250. In detail, the first joint 251 and the second joint 252 may be joined along the joint line CL.

The vent member 230 and the joint line CL may be disposed on opposite sides of the housing 200.

At least a portion of the joint line CL may be formed in the longitudinal direction (Z-axis direction) of the body portion 201 of the housing 200. In the housing 200, the joint 250 and the vent member 230 are disposed on opposite surfaces, and thus the joint line CL may also be disposed on the surface opposite to the vent member 230.

The battery cell 10 may have a double-end tab structure in which the positive terminal portion 320a and the negative terminal portion 320b are disposed on both sides. In this case, the first opening 210 and the second opening 220 may be disposed in both ends of the body portion 201 in the longitudinal direction (Z-axis direction), respectively. Hereinafter, the longitudinal direction of the body portion 201 is also referred to as a ‘first direction’. On the other hand, the joint 250 and the vent member 230 may face each other in a second direction (for example, Y-axis direction) perpendicular to the first direction.

In some embodiments, the housing 200 may be manufactured by bending a plate-shaped member at least once. For example, a manufacturer may bend a flat member several times to produce a box-shaped housing 200 with both sides open as illustrated in FIG. 3.

The body portion 201 of the housing 200 may be formed of a plate-shaped member bent at least once. In this case, the first joint 251 and the second joint 252 constituting the joint 250 of the housing 200 may respectively correspond to at least a portion of both edges of the plate-shaped member.

Hereinafter, with reference to FIGS. 4 to 9, the combination of the vent member 230 according to some embodiments will be described in detail.

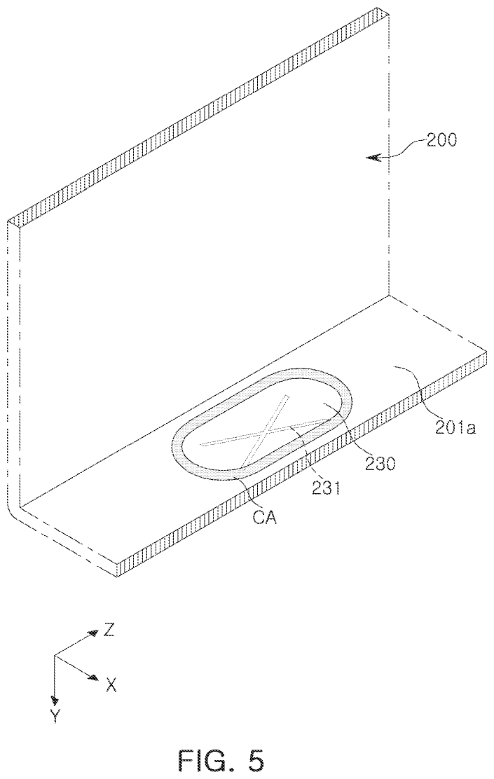

FIG. 4 is an example diagram illustrating the combination of the housing 200 and the vent member 230 of the battery cell 10. FIG. 5 illustrates a state in which the vent member 230 is coupled to the inside of the housing 200. Since the battery cell 10 described in FIGS. 4 and 5 corresponds to the battery cell 10 in FIGS. 1 to 3, overlapping descriptions may be omitted.

The vent member 230 may be seated and coupled to the inner side of the housing 200. For example, the vent member 230 is seated in the venting hole 240 provided in the housing 200 in a direction from the inside to the outside of the housing 200 (for example, in the positive Y-axis direction in FIG. 4), and in this state, the edges thereof may be joined by welding or the like. Of course, as previously described in FIGS. 1 to 3, the joining method between the vent member 230 and the housing 200 is not limited to welding.

The venting hole 240 may include a step portion 241. The vent member 230 may be seated on the step portion 241 of the venting hole 240 and supported so as not to fall out of the housing 200.

The step portion 241 may be formed at the edge of the venting hole 240 of the housing 200 so that the vent member 230 may be stably seated. For example, referring to FIG. 4, the step portion 241 of the venting hole 240 may be formed in a structure having a step with respect to the inner wall of the housing 200.

The vent member 230 may include a seating portion 232 that is seated on the step portion 241 of the venting hole 240. For example, referring to FIG. 4, the seating portion 232 is formed at the edge of the vent member 230 and may be configured to have a step shape corresponding to the shape of the step portion 241.

As the vent member 230 is positioned in the venting hole 240, the seating portion 232 may be disposed to face the step portion 241 in the height direction (for example, Y-axis direction) of the battery cell 10. Since the vent member 230 is seated in a direction from the inside to the outside of the housing 200, the seating portion 232 of the vent member 230 may be disposed closer to the internal space S and the electrode assembly (100 in FIG. 2) than the step portion 241 of the venting hole 240.

In this case, the diameter of a portion of the step portion 241 in the venting hole 240 may be smaller than the width of the seating portion 232 of the vent member 230. In other words, the width of the venting hole 240 is narrower than the width of the vent member 230. For example, referring to FIG. 4, the width of a portion of the step portion 241 of the venting hole 240 in the X-axis direction may be smaller than the width of the seating portion 232 of the vent member 230 in the X-axis direction. Alternatively, the width of a portion of the step portion 241 of the venting hole 240 in the Y-axis direction may be smaller than the width of the seating portion 232 of the vent member 230 in the Y-axis direction. According to this structure, the vent member 230 is stably supported while seated in the venting hole 240 of the housing 200, thereby preventing from being easily separated from the housing 200 even if the internal pressure of the battery cell 10 is continuously applied.

The vent member 230 may include a notch portion 231 that may be broken by the internal pressure of the battery cell 10. For example, an engraved notch portion 231 may be formed on the surface of the vent member 230. The notch portion 231 is thinner than other parts of the vent member 230, and may thus be preferentially fractured when the internal pressure of the battery cell 10 becomes equal to or higher than the reference value.

The notch portion 231 may be formed on a surface of the vent member 230 that faces the outside of the battery cell 10. For example, when one surface of the vent member 230 faces the electrode assembly (100 in FIG. 2) while the vent member 230 is coupled to the venting hole 240 of the housing 200, the notch portion 231 may be formed on the other surface opposite to one surface of the vent member 230.

The notch portion 231 may be configured in an ‘x’ shape as illustrated in FIG. 4, but a detailed shape thereof is not limited to what is illustrated in the drawing.

Referring to FIG. 5, a joint area CA may be formed along the edge of the vent member 230 on the inner side of the housing 200.

When the vent member 230 is welded to the venting hole 240, the joint area CA may be an area where a welding laser is irradiated. For example, with the vent member 230 seated in the venting hole 240, the welding laser is irradiated to at least a portion of the joint area CA inside the housing 200, and thus the vent member 230 and the housing 200 may be coupled to each other.

In detail, since the housing 200 of the battery cell 10 has an openable joint 250 on the side opposite to the venting hole 240, the above-mentioned welding laser may be easily irradiated to the joint area CA.

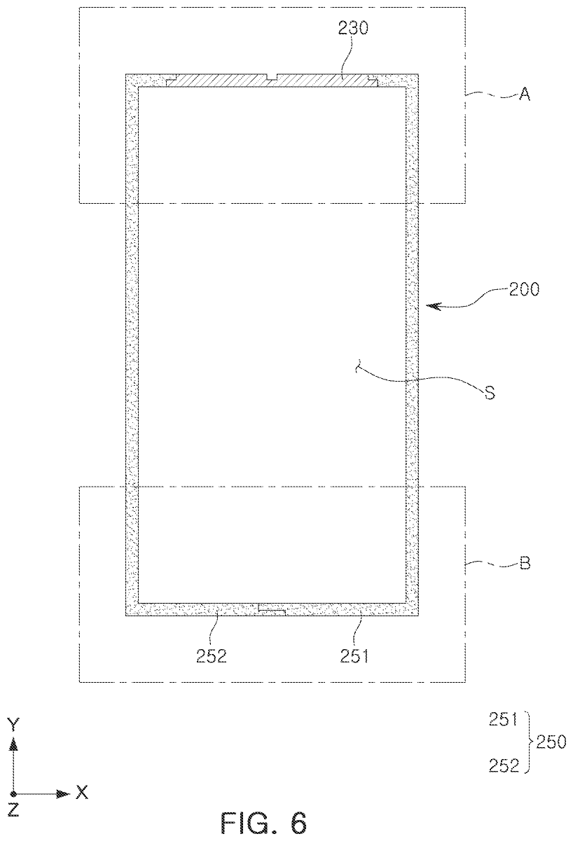

Hereinafter, with reference to FIGS. 6 to 9, the joint 250 of the battery cell 10 and the joining of the vent member 230 using the joint 250 will be described in detail.

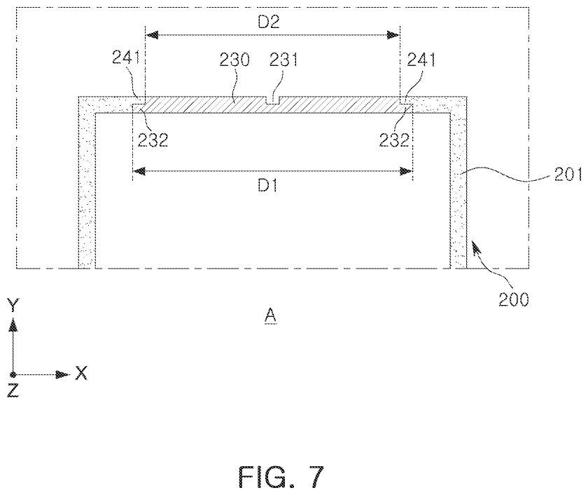

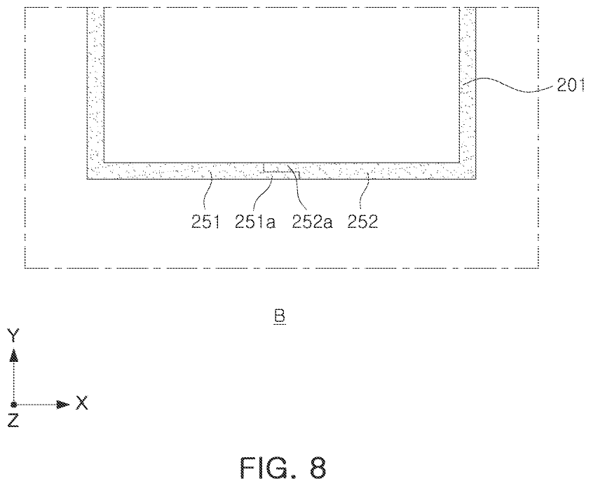

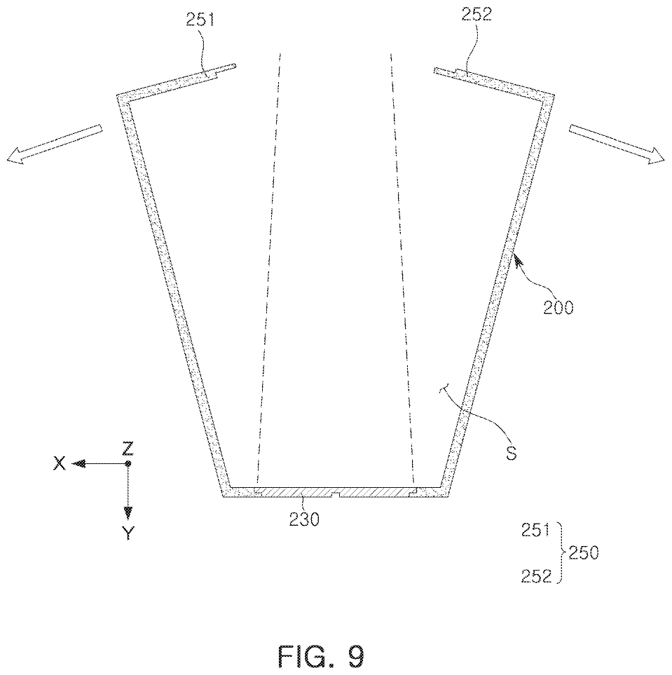

FIG. 6 is a cross-sectional view of the housing 200 taken along line I-I′ of FIG. 3. FIG. 7 is an enlarged view of portion A of FIG. 6. FIG. 8 is an enlarged view of portion B of FIG. 6. FIG. 9 illustrates the joint 250 of the housing 200 in an open state.

Since the battery cell 10 described in FIGS. 6 to 9 corresponds to the battery cell 10 previously described in FIGS. 1 to 5, overlapping descriptions may be omitted.

The housing 200 of the battery cell 10 may include a venting hole (240 in FIG. 4) and a joint 250 that are disposed to face each other with an internal space S therebetween. The vent member 230 may be seated on and coupled to the venting hole (240 in FIG. 4).

The vent member 230 may have a notch portion 231 with an engraved structure. When the pressure inside the battery cell 10 is equal to or higher than a reference value, the vent member 230 having the notch portion 231 may be broken preferentially than other parts of the housing 200. The gas inside the housing 200 is discharged through the broken vent member 230, thereby preventing the internal pressure of the battery cell 10 from increasing to a dangerous level.

The vent member 230 may be coupled to the housing 200 in a direction from the inside to the outside of the housing 200. For example, referring to FIGS. 6 and 7, at least a portion of the vent member 230 may be seated on and coupled to the step portion 241 formed on the inner side of the housing 200 in a direction from the inside to the outside of the housing 200.

The housing 200 may have a step portion 241 on which the vent member 230 is seated, and the vent member 230 may have a seating portion 232 on which the vent member 230 is seated. When the vent member 230 is coupled to the housing 200, the seating portion 232 of the vent member 230 may be disposed further inwardly of the housing 200 than the step portion 241 of the housing 200.

A width D2 of the step portion 241 of the venting hole 240 may be smaller than a width D1 of the seating portion 232 of the vent member 230. Accordingly, even if internal pressure is formed by the gas generated inside the battery cell 10, the vent member 230 is supported by the step portion 241 of the venting hole 240 and may not be separated out of the housing 200.

In addition, due to this structure of the step portion 241, the vent member 230 may be accurately seated in the venting hole 240 of the housing 200.

The housing 200 may further include a joint 250 disposed on the opposite side of the vent member 230. The joint 250 is configured to be openable, so that the joining process of the vent member 230 and the housing 200 may be easily performed.

The joint 250 of the housing 200 may include a first joint 251 and a second joint 252 configured to contact each other.

The first joint 251 and the second joint 252 may have a structure in which they engage each other. For example, as illustrated in FIG. 8, a step 251a formed on the end of the first joint 251 and a step 252a formed on the end of the second joint 252 may be configured to engage with each other. With this engaging structure, the first joint 251 and the second joint 252 may be joined more stably. In addition, even after the first joint 251 and the second joint 252 are joined, the joint 250 may not be easily damaged due to the internal pressure of the battery cell 10.

As the first joint 251 and the second joint 252 are spaced apart from each other, the joint 250 may be opened. Conversely, when the first joint 251 and the second joint 252 come into contact with each other, the joint 250 may be closed.

In the manufacturing process of the battery cell 10, at a stage before the vent member 230 is coupled to the housing 200, the joint 250 may be configured to be openable. For example, at a stage before the vent member 230 is coupled to the housing 200, the first joint 251 and the second joint 252 of the joint 250 may be spaced apart from each other or may be configured not to be joined. In this case, as illustrated in FIG. 9, the joint 250 may be easily opened by external force.

As the joint 250 is opened, the inner side of the housing 200 on which the vent member 230 is seated is exposed, so that the work for joining the vent member 230 may be easily performed. For example, when the vent member 230 is fixed to the housing 200 by welding, a welding laser may be stably irradiated to the inner side of the housing 200 through the open joint 250. (For example, the dotted line in FIG. 9 may be an example of a path where a laser output nozzle is inserted)

For example, since the battery cell 10 according to some embodiments has an openable joint 250 disposed on the opposite side of the vent member 230, the vent member 230, which is seated on the inner side of the housing 200, may be stably coupled to the housing 200.

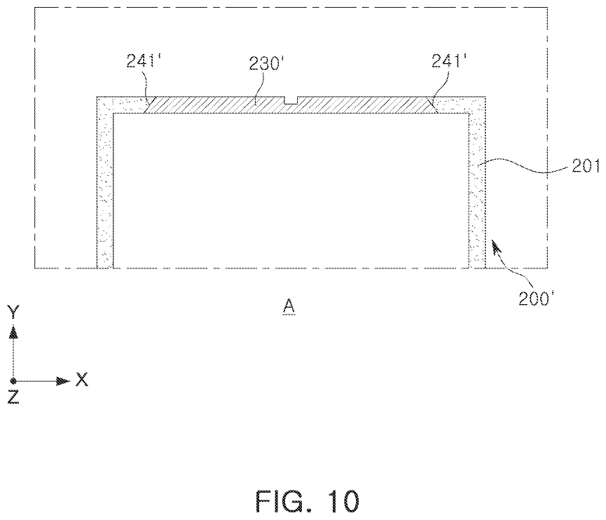

The engagement structure between the vent member 230 and the housing 200 is not limited to the step structure illustrated in FIGS. 6 and 7. For example, as illustrated in FIG. 10, a vent member 230′ and a portion of the housing 200′ in contact therewith may be configured to have an inclined surface.

FIG. 10 is a partial cross-sectional view of a housing 200′ according to another embodiment.

Referring to FIG. 10, a venting hole is formed on one side of the housing 200′, and a vent member 230′ is coupled to a body portion 201 of the housing 200′ to close the venting hole.

The vent member 230′ may be seated on and coupled to a step portion 241′ of the housing 200′ in a direction from the inside to the outside of the housing 200′.

The step portion 241′ on which the vent member 230′ is seated in the housing 200′ may be formed as an inclined surface. In this case, the inclined surface of the step portion 241′ of the housing 200′ may be configured to be inclined so that the spacing between the venting holes gradually narrows in the direction toward the outside of the housing 200′.

Corresponding to the shape of the step portion 241′ of the housing 200′, the edge of the vent member 230′ may also be configured as an inclined surface. For example, the edge of the vent member 230′ may be configured to be inclined so that the width of the vent member 230′ gradually narrows in the direction toward the outside of the housing 200′.

Due to the inclined surface structure of the vent member 230′ and the housing 200′, the exact seating position of the vent member 230′ may be guided in the process of seating the vent member 230′ in the venting hole of the housing 200′.

The inclined angle of the inclined surface of the vent member 230′ may be set variously. Alternatively, a portion of the vent member 230′ in contact with the body portion 201 may be formed as an inclined surface, and the other portion may be formed as a surface perpendicular to the upper surface of the vent member 230′. If necessary, a portion of the vent member 230′ that comes into contact with the body portion 201 may be finished as a horizontal surface in the height direction of the housing (for example, the Y-axis direction) without an inclined portion.

For example, the inclined surface of the vent member illustrated in FIG. 10 is only a part of various embodiments, and the shape of the portion of the vent member 230′ in contact with the body portion 201 may be any shape as long as the vent member 230′ may maintain contact with the body portion 201.

On the other hand, in FIG. 10, all other features except for the structure of the part where the vent member 230′ and the housing 200′ come into contact are the same as those of the vent member 230 and the housing 200 described in FIGS. 1 to 9, and thus, a detailed description thereof may refer to FIGS. 1 to 9.

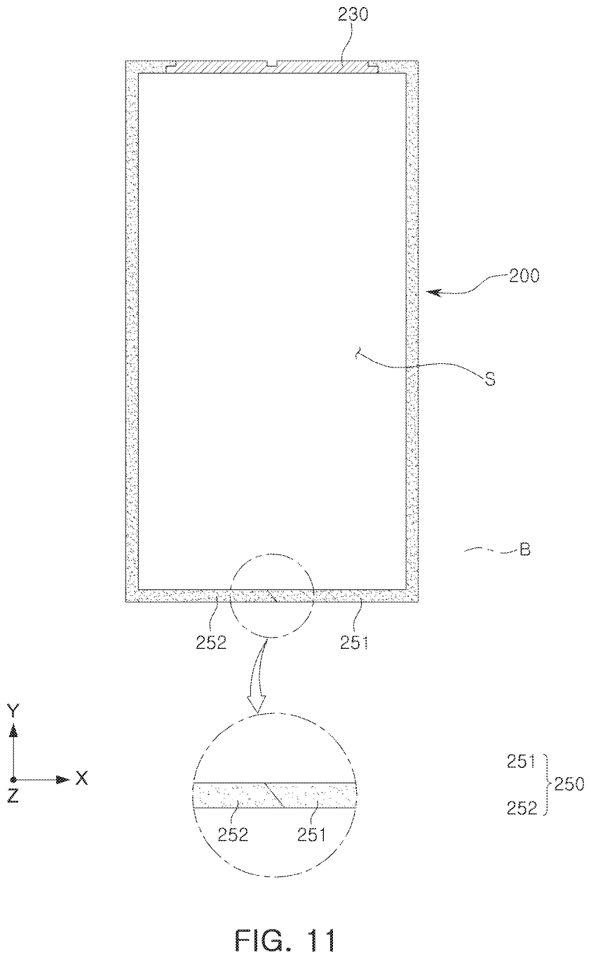

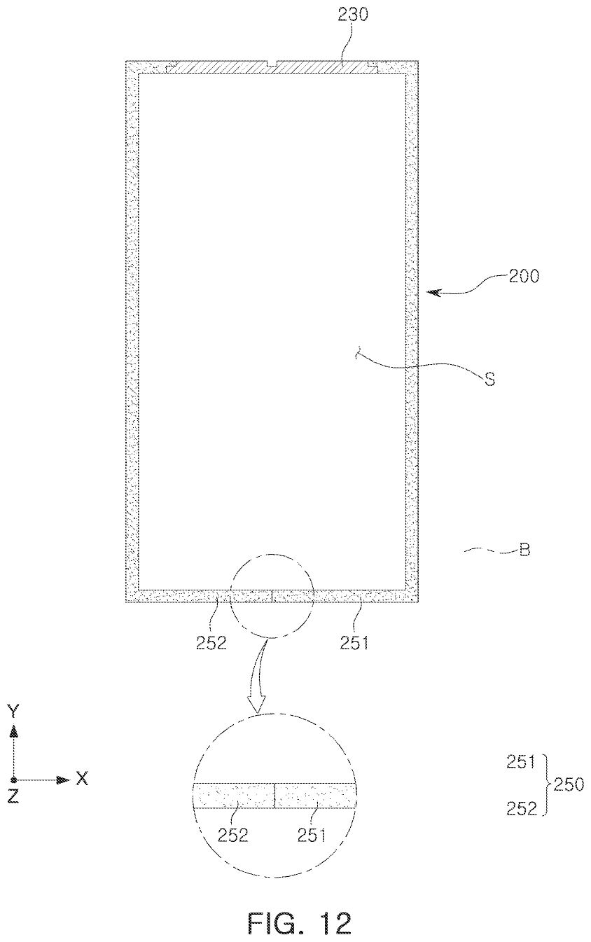

Hereinafter, the shape of the joint according to other embodiments will be described with reference to FIGS. 11 and 12.

FIG. 11 is a cross-sectional view of a housing according to another embodiment. FIG. 12 is a cross-sectional view of a housing according to another embodiment.

The ends of the first joint 251 and the second joint 252 constituting the joint 250 may be provided in various shapes.

For example, referring to FIG. 11, the portion of the first joint 251 that comes into contact with the second joint 252 may be configured as an inclined surface inclined with respect to the height direction (Y-axis direction) of the housing. Correspondingly, the portion of the second joint 252 that comes into contact with the first joint 251 may be configured as an inclined surface that may come into close contact with the inclined surface of the first joint 251.

Alternatively, referring to FIG. 12, the portions of the first joint 251 and the second joint 252 that come into contact with each other may be configured to be horizontal with respect to the height direction (Y-axis direction) of the housing.

In addition to the shapes illustrated in FIGS. 11 and 12, the ends of the first joint 251 and the second joint 252 may have various shapes configured to contact each other.

On the other hand, in the housing 200 illustrated in FIGS. 11 and 12, other features other than the shape of the portion where the first joint 251 and the second joint 252 come into contact with each other are all the same as the features of the housing 200 described in FIGS. 1 to 9, and thus, detailed descriptions thereof may refer to FIGS. 1 to 9.

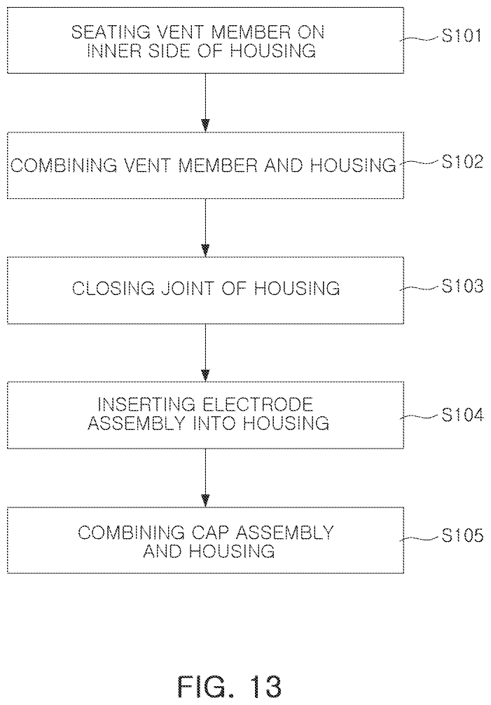

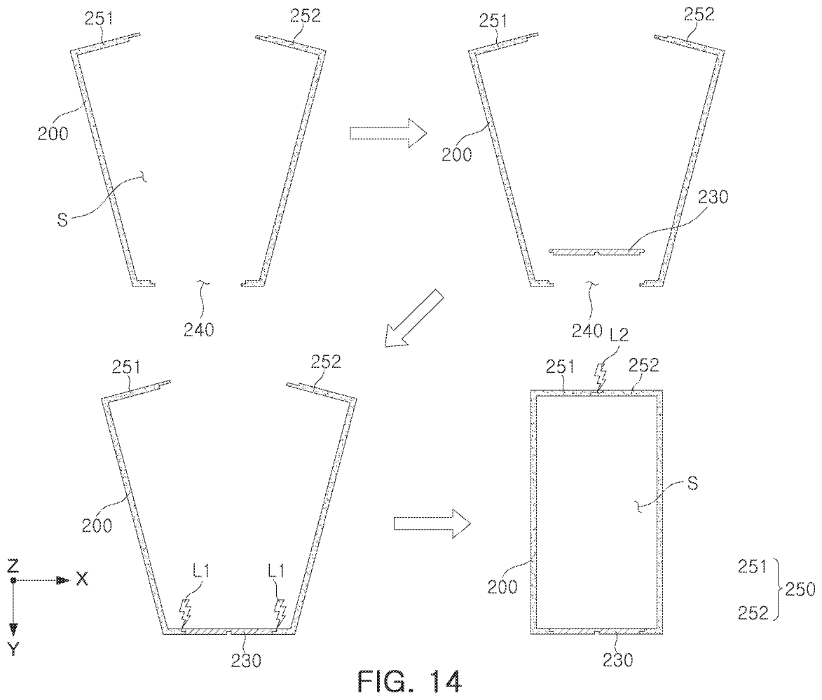

Hereinafter, a method of manufacturing the battery cell 10 according to embodiments will be described with reference to FIGS. 13 and 14.

FIG. 13 is a flowchart illustrating a method of manufacturing a battery cell. FIG. 14 is an example diagram illustrating the coupling or combining process of the housing 200 and the vent member 230.

Since the battery cell and components thereof described in FIGS. 13 and 14 correspond to the battery cell 10 and the components thereof previously described in FIGS. 1 to 12, overlapping descriptions may be omitted.

In some embodiments, a method of manufacturing a battery cell may include preparing a housing for a battery cell (S101, S102, S103), inserting an electrode assembly in the housing (S104), and combining the cap assembly and the housing (S105). Combining an electrode assembly and a cap assembly with the housing may mean inserting an electrode assembly in the housing (S104) and combining the cap assembly and the housing (S105).

The operations of preparing the housing (S101, S102, S103) may include an operation of seating the vent member on the inner side of the housing (S101), an operation of combining the vent member and the housing (S102), and an operation of closing the joint of the housing (S103).

The operation of closing the joint of the housing (S103) may further include joining the first joint and the second joint of the joint along a joint line formed in the longitudinal direction of the housing.

With reference to FIG. 14, the operations of preparing the housing 200 (S101, S102, and S103) will be described in detail. FIG. 13 illustrates at least portions of the operations (S101, S102, and S103) for preparing the housing 200, by way of example, and illustrates the housing 200 being prepared in the following order: upper left, upper right, lower left, and lower right.

The upper left of FIG. 14 illustrates the joint 250 of the housing 200 being opened. For example, in this case, the first joint 251 and the second joint 252 of the joint 250 may be spaced apart from each other, and accordingly, the inner side of the housing 200 may be exposed through the opened joint 250.

A venting hole 240 may be open in the opposite side of the joint 250 of the housing 200. This venting hole 240 may be closed by the vent member 230 combined in a later process.

The upper right of FIG. 14 illustrates the vent member 230 being seated inside the housing 200. The vent member 230 may be seated in the venting hole 240 in a direction from the inside to the outside of the housing 200. The width of the venting hole 240 may be narrower than a width of the vent member 230. At this time, since the joint 250 of the housing 200 is open, the seating process of the vent member 230 may be performed more easily.

The lower left of FIG. 14 illustrates the vent member 230 being joined to the housing 200. A laser welding method may be applied to join the vent member 230 and the housing 200. The combining of the vent member and the housing S102 may further include irradiating a welding laser L1 to a joint area CA of the inner side of the housing 200 through the joint 250 that is open and closing the joint 250.

At this time, since the inner sides of the vent member 230 and the housing 200 are exposed between the open joint 250, the laser L1 for welding may easily reach the joint area (for example, CA in FIG. 5) of the vent member 230.

In detail, when the vent member 230 is seated in a direction from the inside to the outside of the housing 200, irradiating the laser L1 from the inner side of the housing 200 is required to stably bond the vent member 230. Since the housing 200 has a joint 250 configured to be openable on the opposite side of the vent member 230, the nozzle for joining may easily enter the internal space S of the housing 200 through the open joint 250, and the laser L1 for welding may be irradiated accurately and safely.

The lower right of FIG. 14 illustrates the joint 250 being closed after the joining of the vent member 230 is completed.

A laser welding method may be applied to joining the first joint 251 and the second joint 252. The first joint 251 and the second joint 252, which were spaced apart in the previous operation, may be brought into contact with each other, and may be joined to each other by the laser L2 for welding along a joint line (for example, CL in FIGS. 2 and 3), thereby closing the joint 250.

Through this process, the vent member 230 is coupled and the housing 200 with the joint 250 closed may be prepared.

However, as illustrated in the previous drawings, various joining methods other than laser welding may be applied to join the vent member 230 to the housing 200 and to join the first joint 251 and the second joint 252.

Referring again to FIG. 13, after the housing is prepared, an operation of accommodating the electrode assembly in the housing (S104) and an operation of combining the cap assembly and the housing (S105) may be performed.

In the operation of accommodating the electrode assembly in the housing (S104), the electrode assembly may be inserted and accommodated in the internal space of the housing. At this time, the cap assembly may be electrically connected to at least one side of the electrode assembly.

In the operation of combining the cap assembly and the housing (S105), the cap assembly may be coupled to both open sides of the housing to close the internal space of the housing. Cap assemblies having terminal portions of different polarities may be connected to both sides of the electrode assembly, respectively, thereby creating the appearance of a battery cell having positive and negative terminals on both ends.

However, the method of manufacturing a battery cell is not limited to the above-described sequence. For example, the operation of accommodating the electrode assembly in the housing (S104) and the operation of combining the cap assembly and the housing (S105) may be performed sequentially or simultaneously.

In some embodiments, the battery cell 10 may include a vent member 230 that is seated and joined in a direction from the inside to the outside of the housing 200. In this manner, the vent member 230 seated and joined to the inside of the housing 200 is not easily separated or the joined portion is not damaged due to the internal pressure of the housing 200, and thus, the structural stability of the battery cell 10 may be further increased.

In addition, in the battery cell 10 according to embodiments, even when the housing 200 has a thinner thickness than a thickness of the cap plate 310 of the cap assembly 300, the vent member 230 may be stably coupled to the housing 200.

To bond the vent member 230 and the housing 200, the housing 200 of the battery cell 10 may have an openable joint 250 on the opposite side of the vent member 230. Since the joint area CA between the vent member 230 and the inner side of the housing 200 may be exposed through the open joint 250, the joining process of the vent member 230 may be performed more smoothly, and the efficiency of the assembly process of the battery cell 10 may be increased.

In addition, in the double-end tab battery cell 10 in which the positive terminal portion 320 and the negative terminal portion 320 are disposed on both sides, the vent member 230 may be easily coupled to the side of the housing 200, which has the technical advantage of being able to set the venting direction of the battery cell 10 in various manners.

As set forth above, according to some embodiments, a battery cell in which a vent member is placed in the housing to allow various gas discharge paths to be set may be implemented.

Additionally, according to some embodiments, a battery cell having increased structural stability may be implemented by combining a vent member with the inside of the housing.

Additionally, since the battery cell has a joint configured to be openable on the opposite side of the surface on which the vent member is seated, the vent member may be stably coupled to the housing.

Only specific examples of implementations of certain embodiments are described. Variations, improvements and enhancements of the disclosed embodiments and other embodiments may be made based on the disclosure of this patent document.

What is claimed is:

1. A battery cell comprising:
a housing having an internal space in which an electrode assembly is accommodated;
a cap assembly coupled to the housing and closing the internal space; and
a vent member coupled to the housing and configured to open when internal pressure of the housing is equal to or higher than a reference value,
wherein the vent member is coupled to an inner side of the housing.

2. The battery cell of claim 1, wherein the housing further includes a venting hole in which the vent member is seated,
wherein the vent member is seated in the venting hole in a direction from an inside to an outside of the housing.

3. The battery cell of claim 2, wherein the venting hole includes a step portion, and the vent member includes a seating portion seated on the step portion,
wherein the seating portion is disposed closer to the electrode assembly than the step portion.

4. The battery cell of claim 2, wherein a width of the venting hole is narrower than a width of the vent member.

5. The battery cell of claim 1, wherein the housing includes a joint including a first joint and a second joint facing and coupled to each other.

6. The battery cell of claim 5, wherein the housing further includes a venting hole to which the vent member is coupled, and
the joint is disposed on a side opposite to the venting hole.

7. The battery cell of claim 5, wherein the first joint and the second joint are welded to each other along a joint line,
wherein the joint line is formed in a longitudinal direction of the housing.

8. The battery cell of claim 5, wherein a step is formed in a position in which the first joint and the second joint come into contact with each other.

9. The battery cell of claim 1, wherein the housing has an open shape at both ends in a longitudinal direction, and
the cap assembly is coupled to both ends of the housing.

10. The battery cell of claim 1, wherein the vent member includes a notch portion configured to be broken by internal pressure of the housing.

11. A method of manufacturing a battery cell, comprising:
seating a vent member on an inner side of a housing;
combining the vent member and the housing; and
combining an electrode assembly and a cap assembly with the housing,
wherein the vent member is configured to open when internal pressure of the housing is equal to or higher than a reference value.

12. The method of claim 11, wherein the housing includes a joint configured to be openable, and
wherein the combining of the vent member and the housing further includes,
irradiating a welding laser to a joint area of the inner side of the housing through the joint that is open; and
closing the joint.

13. The method of claim 12, wherein the joint includes a first joint and a second joint configured to contact with each other, and
wherein the closing of the joint includes joining the first joint and the second joint along a joint line formed in a longitudinal direction of the housing.

14. The method of claim 12, wherein the vent member and the joint are disposed on two opposing surfaces of the housing, respectively.

15. The method of claim 11, wherein the vent member is seated in a venting hole of the housing in a direction from an inside to an outside of the housing, and
a width of the venting hole is narrower than a width of the vent member.

16. A housing for a battery, comprising:
a body portion having an internal space in which an electrode assembly is accommodated,
wherein the body portion includes,
a first surface on which a joint configured to be opened and closed is disposed; and
a second surface in which a venting hole configured to allow gas generated in the internal space to be discharged is disposed.

17. The housing for a battery of claim 16, wherein the joint includes a first joint and a second joint configured to contact and be joined to each other.

18. The housing for a battery of claim 17, wherein the body portion is formed of a plate-shaped member bent at least once,
wherein at least portions of edges of the plate-shaped member on both sides form the first joint and the second joint.

19. The housing for a battery of claim 16, further comprising a first opening and a second opening disposed in both ends of the body portion in a first direction,
wherein the first surface and the second surface oppose each other in a second direction, perpendicular to the first direction.

20. The housing for a battery of claim 16, further comprising a vent member coupled to the venting hole and configured to open when internal pressure of the internal space is equal to or higher than a reference value.
